(19) United States
(12) Patent Application Publication
(10) Pub. No.: US 2004/0181549 A1
(43) Pub. Date: Sep. 16, 2004

(54) Direct maintenance system for unscheduled, predictive, and preventive maintenance of critical process equipment

(76) Inventor: James D. Pate, Derby, KS (US)

Correspondence Address: LSI Logic Corporation, Corporate Legal Department, Intellectual Property Services Group, 1551 McCarthy Boulevard, M/S D-106, Milpitas, CA, 95035, US

(21) Appl. No.: 10/387,995

(22) Filed: Mar. 13, 2003

(51) Int. Cl. G06F 17/00

(52) U.S. Cl. 707/104.1

(57) ABSTRACT

A maintenance database is provided, which includes maintenance instruction documents. A communications system generates alarm messages, which include maintenance instructions for resolving the alarm condition. The communications system may distribute these alarm messages to appropriate personnel. A direct maintenance viewer receives alarm messages and presents an interface for viewing the maintenance instructions. The maintenance instruction documents may present maintenance instructions as a series of main steps. Each main step may include one or more detailed step. Each main step or detailed step may have a media file associated therewith. Media files may include audio instructions, photographs, diagrams, three-dimensional models, and/or video instructions. The direct maintenance viewer may forward alarm messages and return acknowledgement and resolution messages.

### BACKGROUND OF THE INVENTION

1. Technical Field

The present invention relates to control systems and, in particular, to alarm monitoring of critical process equipment. Still more particularly, the present invention provides a method, apparatus, and program for communicating maintenance instructions for alarms generated in a manufacturing environment.

2. Description of the Related Art

Typically, manufacturing environments, such as assembly plants, chemical treatment plants, integrated circuit fabrication facilities, etc., depend upon equipment to remain in operation. Equipment failures lead to unscheduled downtime, which results in unexpected monetary loss. These equipment failures should be diagnosed and resolved as quickly as possible to reduce costs.

Distributed control systems (DCS) employ a manufacturing execution and control system to monitor and control process critical equipment. One such system is Supervisory Control and Data Acquisition (SCADA), which is an industrial measurement and control system consisting of a central host or master, one or more data gathering and control units, and a collection of standard or custom software to monitor and control remotely located field data elements.

When an alarm condition occurs, such as when a temperature exceeds a threshold or a piece of equipment fails altogether, an alarm message is generated. Alarm messages may be distributed to appropriate personnel, such as a technician or a supervisor. However, given the alarm message and the equipment associated with the alarm condition, the recipient must diagnose the failure and determine the appropriate action to be taken.

There are three basic levels of maintenance. The first level is fire fighting, which involves restoring failed equipment and restoring this equipment to operative status. Fire fighting maintenance must be performed promptly and efficiently. The second level of maintenance is preventative maintenance (PM), which involves performing operations to prevent future failure. This level of maintenance may include replacing worn belts and the like. A third level of maintenance is predictive maintenance (PdM), which involves performing operations on equipment that are predicted to fail in the future. For example, if a temperature exceeds a threshold, one may predict that the equipment will fail in the near future. These levels of maintenance make up total productive maintenance (TPM).

Typically, maintenance instructions are available in hard-copy form. The technician, for example, must identify, locate, and retrieve the proper maintenance instructions and carry them to the site of the equipment failure. This is disadvantageous, because the technician must use the correct instructions. Furthermore, hard-copy libraries suffer from file integrity problems.

Therefore, it would be advantageous to provide an improved method, apparatus, and program for communicating maintenance instructions for alarms generated in a manufacturing environment.

### SUMMARY OF THE INVENTION

The present invention provides a maintenance database including maintenance instruction documents. A communications system generates alarm messages, which include maintenance instructions for resolving the alarm condition. The communications system may distribute these alarm messages to appropriate personnel. A direct maintenance viewer receives alarm messages and presents an interface for viewing the maintenance instructions. The maintenance instruction documents may present maintenance instructions as a series of main steps. Each main step may include one or more detailed step. Each main step or detailed step may have a media file associated therewith. Media files may include audio instructions, photographs, diagrams, three-dimensional models, and/or video instructions. The direct maintenance viewer may forward alarm messages and return acknowledgement and resolution messages.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram of a direct maintenance system in accordance with a preferred embodiment of the present invention;

FIGS. 2A-2C are diagrams illustrating direct maintenance systems with direct maintenance viewers in accordance with a preferred embodiment of the present invention;

FIG. 3 is a diagram illustrating an example database entry for a maintenance document in accordance with a preferred embodiment of the present invention;

FIGS. 4A and 4B are example screens of display for a direct maintenance viewer in accordance with a preferred embodiment of the present invention;

FIG. 5 is a flowchart illustrating the operation of a communications/control system in accordance with a preferred embodiment of the present invention; and

FIG. 6 is a flowchart illustrating the operation of a direct maintenance viewer in accordance with a preferred embodiment of the present invention.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

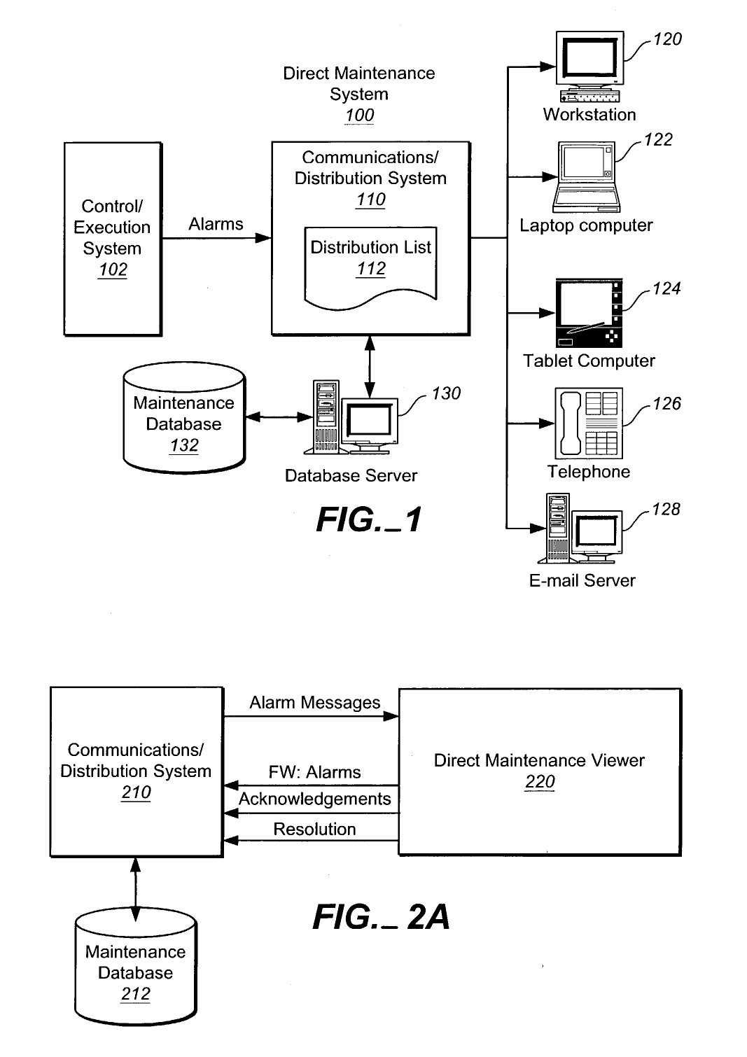

With reference now to the figures and in particular with reference to FIG. 1, a block diagram of a direct maintenance system is shown in accordance with a preferred embodiment of the present invention. Direct maintenance system 100 includes control/execution system 102, which monitors and controls the operation of process critical equipment. Control/execution system 102 generates alarms when alarm conditions occur. Alarms may identify, for example, equipment, instruments, and an alarm type to assist in diagnosis.

Communications/distribution system 110 receives alarms and distributes alarm messages to remote terminal units (RTU). Alarm messages may be distributed using distribution list 112, which matches equipment identifications and alarm types to appropriate personnel and/or remote terminal units. A remote terminal unit may be, for example, desktop workstation 120, laptop computer 122, tablet computer 124, telephone 126, or electronic mail server 128.

In accordance with a preferred embodiment of the present invention, when an alarm message is generated, communications/distribution system 110 retrieves a maintenance instructions data structure from maintenance database 132, via database server 130. The alarm message generated by the communications/distribution system includes maintenance instructions from the maintenance instruction data structure. Combinations of alarm conditions may also determine an alarm message and/or maintenance instructions. The RTU may then present the maintenance instructions to a technician to assist in failure resolution.

Direct maintenance system 100, as shown in FIG. 1, may be implemented within a distributed control system. For example, communications/distribution system 100 may use Supervisory Control and Data Acquisition (SCADA) technology. Control/execution system 102 may also be embodied as a plurality of field data gathering and control units in a SCADA system. However, direct maintenance system 100 may be implemented within other distributed control systems or manufacturing environments within the scope of the present invention.

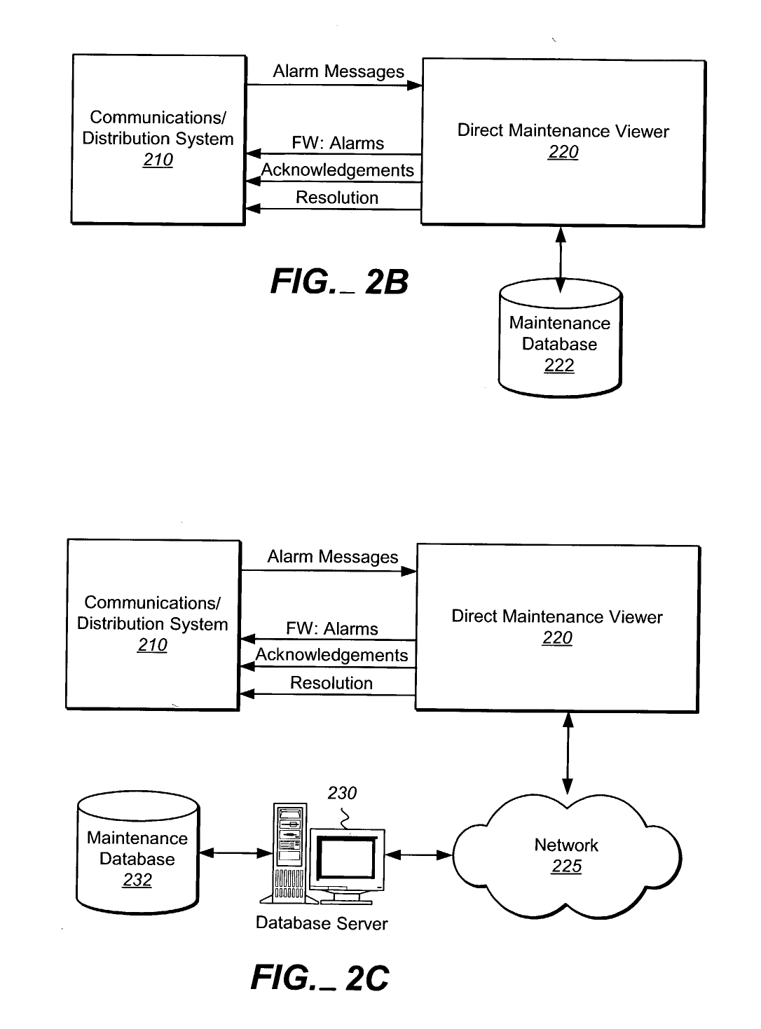

With reference to FIGS. 2A-2C, diagrams illustrating direct maintenance systems with direct maintenance viewers are shown in accordance with a preferred embodiment of the present invention. More particularly, with reference to FIG. 2A, communications/distribution system 210 distributes an alarm message to direct maintenance viewer 220. The communications/distribution system retrieves maintenance instructions information from maintenance database 212 and includes maintenance instructions in the alarm message.

The direct maintenance viewer may forward alarm messages to a supervisor or other party. A user may view the maintenance instructions using direct maintenance viewer 220. As the user executes the instructions, the direct maintenance viewer may return acknowledgement messages to allow the supervisor to monitor the progress of the technician. Therefore, if a particular step typically takes five minutes and it has been thirty minutes since the last acknowledgement, the supervisor may decide to contact the technician. When the user completes execution of the maintenance instructions, the direct maintenance viewer may return a resolution message.

FIG. 2B illustrates an alternative embodiment of the present invention. Communications/distribution system 210 distributes an alarm message to direct maintenance viewer 220. The communications/distribution system includes alarm condition information in the alarm message. The alarm condition information may include, for example, an equipment identification (ID), an instrument identification, and an alarm type. When the alarm message is received at direct maintenance viewer 220, the direct maintenance viewer may use the alarm condition information to search for and retrieve the maintenance instructions from maintenance database 222.

Alternatively, the alarm message may include a direct reference to maintenance instructions in maintenance database 222. For example, the communications/distribution system may include a lookup for associating alarm conditions with maintenance instruction documents. The communications/distribution system may then include a maintenance document identification, or document number, in the alarm message. With the maintenance document expressly identified in the alarm message, direct maintenance viewer 220 may simply retrieve the appropriate maintenance document for presentation.

Turning now to FIG. 2C, yet another alternative embodiment of the present invention is depicted. Communications/distribution system 210 distributes an alarm message to direct maintenance viewer 220. The communications/distribution system includes alarm condition information in the alarm message. The alarm condition information may include, for example, an equipment identification, an instrument identification, and an alarm type. Alternatively, the alarm message may include a direct reference to maintenance instructions in maintenance database 222. When the alarm message is received at direct maintenance viewer 220, the direct maintenance viewer may use information in the alarm message to search for and retrieve the maintenance instructions from maintenance database 232.

The direct maintenance system contains a network 225, which is the medium used to provide communications links between various devices and computers connected together within the direct maintenance system. Network 225 may include connections, such as wire, wireless communication links, or fiber optic cables. In the depicted example, database server 230 is connected to network 225 along with direct maintenance viewer 220. In the depicted example, database server 230 provides maintenance instructions to direct maintenance viewer 220. The direct maintenance system may include additional servers, clients, and other devices not shown.

In the depicted example, the direct maintenance system is implemented within the Internet with network 225 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, the direct maintenance system also may be implemented as a number of different types of networks, such as for example, an intranet, a local area network (LAN), or a wide area network (WAN). FIGS. 1 and 2A-2C are intended as examples, and not as architectural limitations for the present invention.

Using network 225, technicians, supervisors, outside vendors, and other concerned parties may contribute maintenance instructions to maintenance database 232. As maintenance instructions are expanded, updated, simplified, or made obsolete, the maintenance database may be managed through database server 230.

Direct maintenance viewer 220, as shown in FIGS. 2A-2C, may be implemented on a remote terminal unit, such as workstation 120, laptop computer 122, or tablet computer 124 in FIG. 1. The direct maintenance viewer may also be implemented within any other computer device capable of displaying the alarm information and maintenance instructions, such as, for example, a cellular telephone device or hand-held computer device. The alarm message may also be communicated through a messaging service, such as e-mail server 128 in FIG. 1. Upon receipt, the alarm information and maintenance instructions may be presented by direct maintenance viewer 220.

In accordance with a preferred embodiment of the present invention, direct maintenance viewer 220 presents the maintenance instructions using a graphical user interface. However, maintenance instructions may also be presented using a text-to-voice system to a telephone device, such as telephone 126 in FIG. 1. Using voice or dial-tone commands, a user may navigate through the maintenance instructions to perform the required maintenance operations.

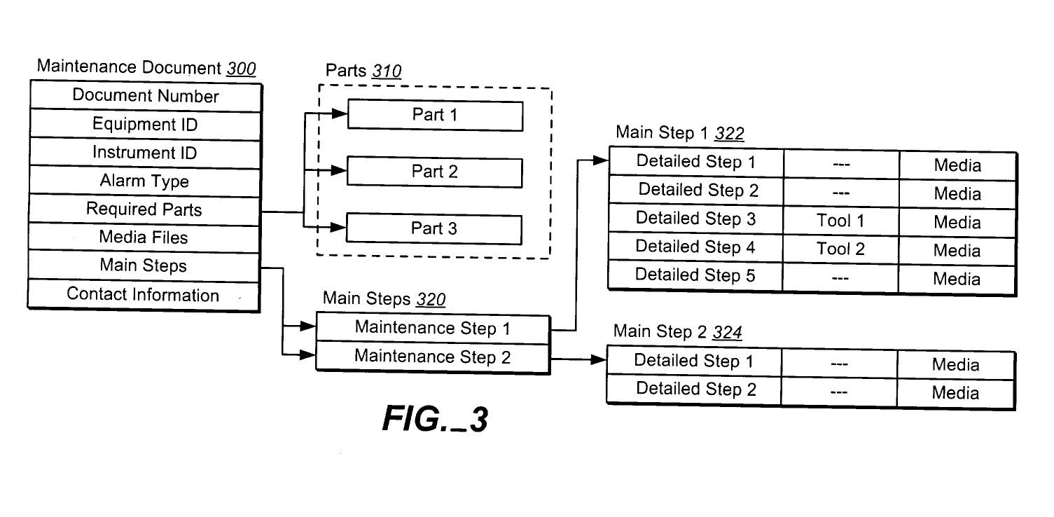

With reference now to FIG. 3, a diagram illustrating an example database entry for a maintenance document is shown in accordance with a preferred embodiment of the present invention. Maintenance document 300 is a data structure that represents a document of maintenance instructions. The maintenance document may include several fields, such as document number, equipment ID, instrument ID, alarm type, required parts, media files, main steps, and contact information. The equipment ID, instrument ID, alarm type, and media files may be used to gain an overall understanding of the problem. Contact information may be used to contact support personnel, such as the equipment manufacturer, for assistance. The maintenance document may also include supplemental information. For example, if the alarm type refers to a temperature exceeding a predetermined threshold, the temperature information may be included.

The fields may contain references to other records in the maintenance database or in other databases. For example, the required parts field may refer to parts records 310. Furthermore, contact information may refer to a separate record so that the contact information need not be reproduced for every maintenance document in the database. Media files may also be stored as supplemental files, such as audio files, image files, video files, or three-dimensional model (e.g., computer aided design (CAD)) files.

Main steps may also refer to a separate record or records. Furthermore, each main step in main steps records 320 refers to a list of detailed steps. For example, main step 1 322 includes a series of five detailed step. Also, in the example shown in FIG. 3, main step 2 324 includes a series of two detailed step. Each detailed step may optionally include a required tool and/or media file, in addition to the actual detailed step instruction. The tool field may refer to separate tool records in the same or a different database, similar to the manner in which required parts are referred in the maintenance document. Again, media files may also be stored as supplemental files, such as audio files, image files, video files, or three-dimensional model (e.g., computer aided design (CAD)) files.

In a preferred embodiment of the present invention, the example records shown in FIG. 3 are embodied in a relational database. However, any data structure for storing maintenance instructions may be used in the present invention. The actual organization of the maintenance instruction information may vary. The maintenance document of the present invention may also include more or fewer fields depending on the implementation.

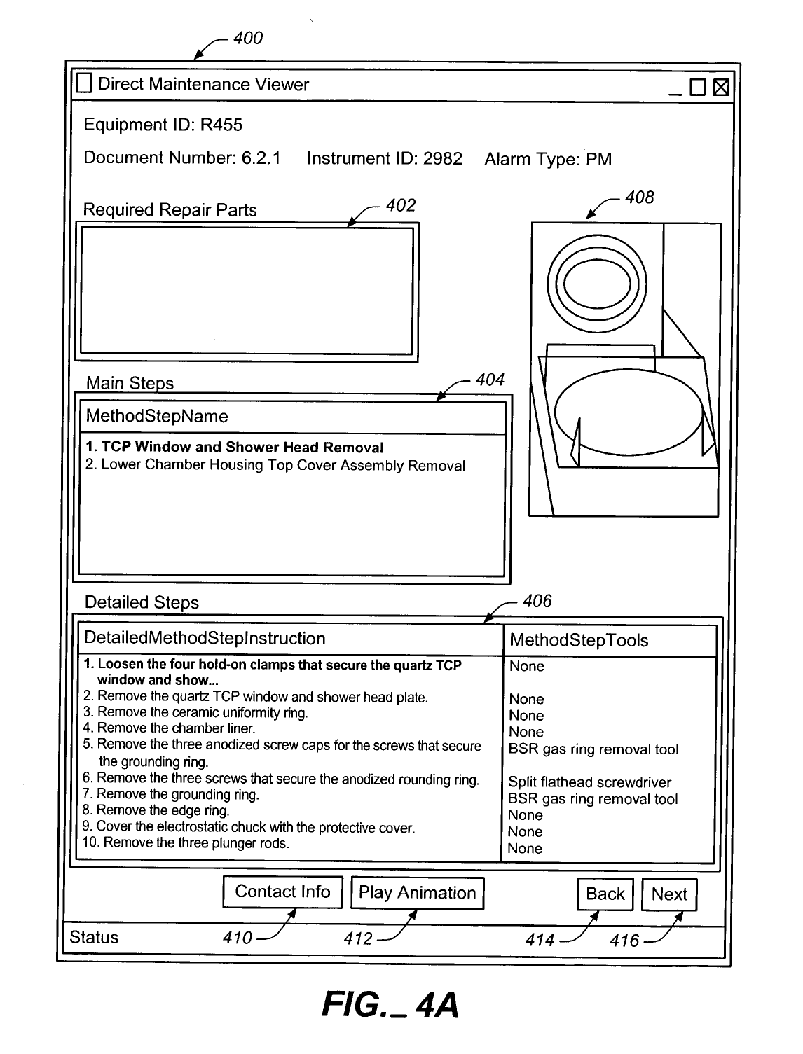

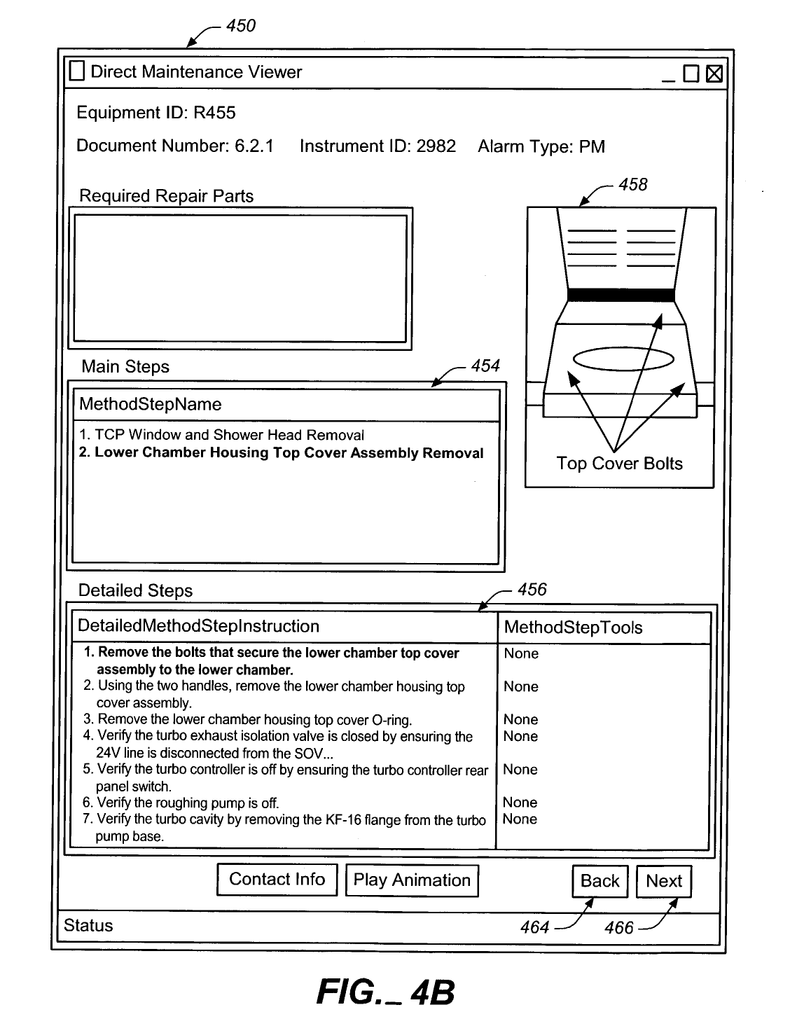

With reference to FIGS. 4A and 4B, example screens of display for a direct maintenance viewer are shown in accordance with a preferred embodiment of the present invention. More particularly, with reference to FIG. 4A, direct maintenance viewer window 400 includes a display area for displaying maintenance instruction information. The display area may display, for example, the equipment ID, document number, instrument ID, and alarm type. In addition, the display area includes required parts field 402, main steps field 404, detailed steps field 406, and media display area 408. A user may select “Contact Info” button 410 to view contact information.

Contact information may include telephone numbers, pager numbers, or electronic mail addresses of a contact person. Contact persons may include support personnel, a supervisor, a representative or engineer from the manufacturer, supply-chain management personnel, purchasing personnel, etc. Selecting “Contact Info” button 410 may also result in a user interface being displayed wherein a user may select a contact person and type a message in a text field. The message may then be sent to the selected party automatically using the contact information, such as a pager number or electronic mail address.

Required repair parts field 402 includes a list of parts that must be repaired or replaced. For example, if the alarm is generated when a temperature exceeds a predetermined threshold, a fan or other cooling unit may need to be replaced. Main steps field 404 lists the main steps to be taken in the maintenance operation. When a main step is selected in field 404, detailed steps associated with the selected main steps are presented in detailed steps field 406. The actual instructions are presented in field 406, along with tools needed to perform the step. Other instruction information may also be displayed within the scope of the invention.

Media files presented in media display area 408 may be associated with the maintenance document, a particular main step, or a selected detailed step. The media display area may present controls for playing an audio file. If the media file is an image file, the media display area may simply present the image, which may include, for example, a photograph of the equipment or a diagram illustrating the detailed instruction step. Furthermore, the media display area may also include graphical controls for interacting with a three-dimensional model or video file. If a video media file is available, the user may also select “Play Animation” button 412 to play the video presentation.

The user may explicitly select a main step in main step field 404 by clicking on the step with a mouse or by moving a keyboard cursor to the desired main step. Similarly, the user may explicitly select a particular detailed step in detailed step field 406 by clicking on the step with a mouse or by moving a keyboard cursor to the desired detailed step. The user may also navigate the main steps or the detailed steps using “Back” button 414 and “Next” button 416. Selecting the “Next” button may indicate completion of the step, in response to which the direct maintenance viewer may return an acknowledgement message. Selecting the “Next” button also causes the next step to be highlighted and any media file associated with the step to be presented in the media display area.

Stepping through the steps may create a maintenance log. Deviations in the maintenance log may indicate when a technician performed a maintenance operation improperly. The interface shown in FIG. 4A may also include a comments field (not shown) in which the technician may type added information. For example, a technician may begin maintenance on equipment for an alarm condition and, upon visual inspection, notice another maintenance operation that may be performed. For example, a technician may respond to an alarm condition and notice a belt that is worn. The technician may then replace the belt and indicate this operation in the comments field.

The maintenance instructions may also include conditional logic. Thus, after performing a particular main or detailed step, the user may be asked a question. For example, after opening a piece of equipment, the instructions may ask the user whether the seal around a particular part is damaged. These conditions may be presented as questions, check boxes, radio buttons, and the like. As the user answers the conditions, more instructions may be presented until the maintenance operation is complete.

Turning now to FIG. 4B, direct maintenance viewer window 450 includes a display area for displaying maintenance instruction information. In this example, the second main step is selected in main steps field 454. Detailed steps associated with the selected main step are presented in detailed steps field 456. The first detailed step in detailed steps field 456 is highlighted. As shown in this example, a media file associated with the selected detailed step is presented in media display area 458. As described above, the user may return to the previous step using “Back” button 464 or proceed to the next step using “Next” button 466. As the user navigates through the maintenance instructions, the media presented in media display area 458 changes to correspond to the highlighted step.

As shown in FIGS. 4A and 4B, maintenance instructions include main steps and detailed steps. These instructions may also be broken up into different levels of expertise. Thus, if a user is considered an “expert,” then the user is required only to step through the main steps. However, if the user is considered a “novice,” the user is required to step through the detailed steps. The levels of expertise may be set within the direct maintenance viewer interface.

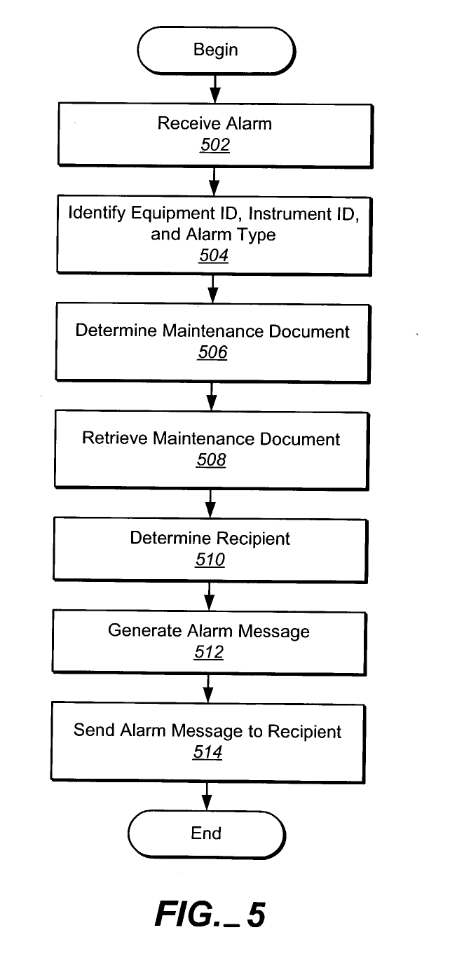

With reference to FIG. 5, a flowchart illustrating the operation of a communications/control system is shown in accordance with a preferred embodiment of the present invention. The process begins and receives an alarm (step 502). The process identifies the equipment identification, instrument identification, and alarm type (step 504) and determines the maintenance document appropriate for the alarm (step 506). Then, the process retrieves the maintenance document (step 508). Thereafter, the process determines a recipient or recipients for the alarm message (step 510) and generates the alarm message (step 512). Next, the process sends the alarm message to the recipient or recipients (step 514) and ends.

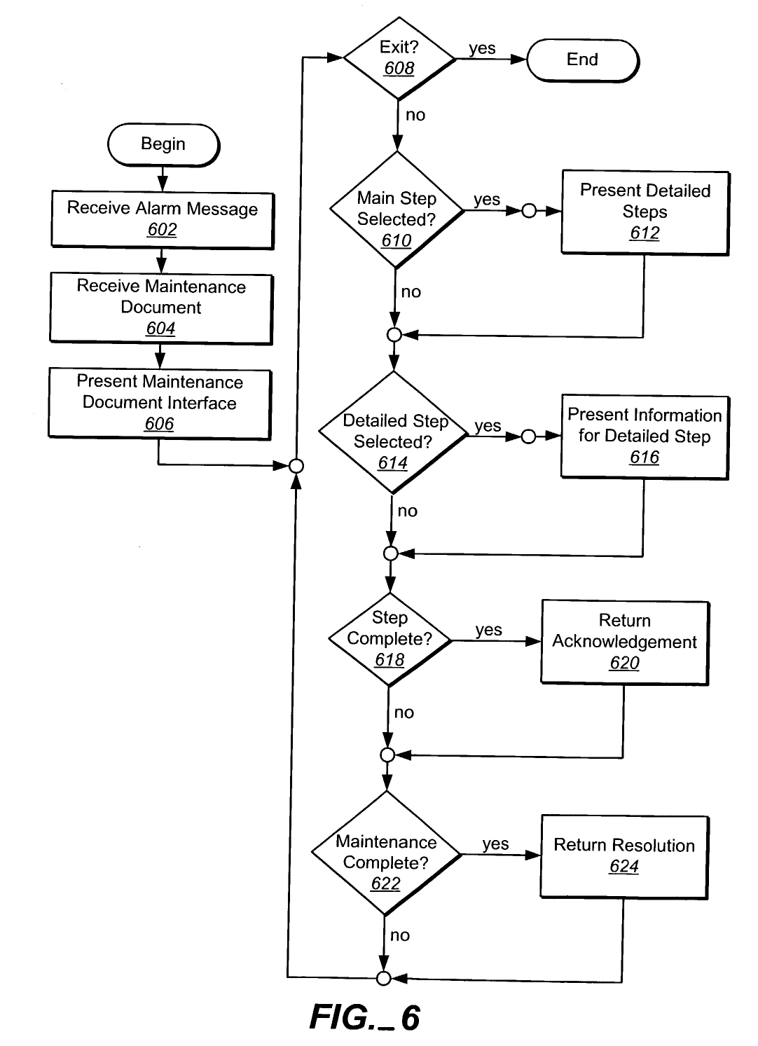

Next, with reference now to FIG. 6, a flowchart illustrating the operation of a direct maintenance viewer is shown in accordance with a preferred embodiment of the present invention. The process begins and receives an alarm message (step 602). In response to receiving the alarm message, the process receives a maintenance document associated with the alarm message (step 604). The maintenance document may be referenced in the alarm message or may be embedded within the alarm message. Thereafter, the process presents the maintenance document in a maintenance document user interface (step 606).

Next, a determination is made as to whether an exit condition exists (step 608). An exit condition may exist, for example, when the direct maintenance viewer is shut down or when the direct maintenance document interface window is closed. If an exit condition exists, the process ends. However, if an exit condition does not exist in step 608, a determination is made as to whether a main step is selected (step 610). A main step may be selected by expressly selecting a step with, for example, a mouse click or keyboard cursor. A main step may also be selected by stepping through the main instruction steps, such as by using “Back” and “Next” buttons, as shown in FIGS. 4A and 4B. If a main step is selected in step 610, the process presents the detailed steps associated with the selected main step (step 612).

In response to presenting detailed instruction steps or if no main step is selected in step 610, a determination is made as to whether a detailed step is selected (step 614). A detailed instruction step may be selected by express selection with, for example, a mouse click or keyboard cursor. A detailed instruction step may also be selected by stepping through the detailed instructions, such as by using “Back” and “Next” buttons, as shown in FIGS. 4A and 4B. If a detailed step is selected in step 614, the process presents information for the detailed step (step 616). This information may include the actual instruction text, required tools, and media files associated with the detailed step.

In response to presenting information for the detailed instruction step or if no detailed step is selected in step 614, a determination is made as to whether a step is completed (step 618). If a step is completed, the process returns an acknowledgement message (step 620) and a determination is made as to whether the maintenance operation is complete (step 622). If a step is not completed in step 618, the process proceeds directly to step 622 to determine whether the maintenance operation is completed.

If the maintenance operation is complete, the process returns a resolution message (step 624) and returns to step 608 to determine whether an exit condition exists. If, however, the maintenance operation is not complete in step 622, the process returns to step 608 to determine whether an exit condition exists.

Thus, the present invention solves the disadvantages of the prior art by providing a maintenance database including maintenance instruction documents. A communications system generates alarm messages, which include maintenance instructions for resolving the alarm condition. The communications system may distribute these alarm messages to appropriate personnel. A direct maintenance viewer receives alarm messages and presents an interface for viewing the maintenance instructions. The maintenance instruction documents may present maintenance instructions as a series of main steps. Each main step may include one or more detailed step. Each main step or detailed step may have a media file associated therewith. Media files may include audio instructions, photographs, diagrams, three-dimensional models, and/or video instructions. The direct maintenance viewer may forward alarm messages and return acknowledgement and resolution messages.

What is claimed is:

1. A method for direct maintenance of critical process equipment, the method comprising:
receiving an alarm;
identifying maintenance instructions for the alarm;
generating an alarm message, wherein the alarm message includes the maintenance instructions; and
distributing the alarm message to at least one recipient.

2. The method of claim 1, wherein the step of distributing the alarm message to the at least one recipient includes:
identifying the at least one recipient from a distribution list; and
sending the alarm message to the at least one recipient.

3. The method of claim 1, wherein the maintenance instructions are retrieved from a maintenance database.

4. The method of claim 1, wherein the maintenance instructions are stored in a maintenance database and the alarm message includes a reference to the maintenance instructions.

5. The method of claim 1, wherein the step of identifying maintenance instructions includes identifying the maintenance instructions based on the alarm in combination with at least one other alarm.

6. The method of claim 1, wherein the at least one recipient includes at least one of a desktop computer, a laptop computer, a tablet computer, a telephone, or an electronic mail server.

7. A method for direct maintenance of critical process equipment, the method comprising:
receiving an alarm message, wherein the alarm message includes maintenance instructions;
presenting the maintenance instructions.

8. The method of claim 7, wherein the maintenance instructions include main steps and detailed steps.

9. The method of claim 8, wherein users of a first expertise level are required to complete the main steps and users of a second expertise level are required to complete the detailed steps.

10. The method of claim 7, further comprising:
generating a resolution message responsive to maintenance being completed.

11. The method of claim 7, further comprising:
generating an acknowledgement responsive to a maintenance instruction being completed.

12. The method of claim 7, further comprising:
updating a maintenance log responsive to a maintenance instruction being completed.

13. The method of claim 7, wherein the maintenance instructions include at least a first step and wherein the maintenance instruction includes a media file for the first step.

14. The method of claim 13, further comprising:
presenting the media file to the user.

15. The method of claim 14, further comprising:
presenting controls for interacting with the media file.

16. The method of claim 13, wherein the media file is one of an audio file, an image, a diagram, a video file, and a three-dimensional model.

17. The method of claim 7, wherein the maintenance instructions are stored in a maintenance database and the alarm message includes a reference to the maintenance instructions.

18. The method of claim 7, wherein the step of presenting the maintenance instructions includes presenting the maintenance instructions in a graphical user interface.

19. An apparatus for direct maintenance of critical process equipment, the apparatus comprising:
receipt means for receiving an alarm;
identification means for identifying maintenance instructions for the alarm;
generation means for generating an alarm message, wherein the alarm message includes the maintenance instructions; and
distribution means for distributing the alarm message to at least one recipient.

20. The apparatus of claim 19, wherein the distribution means includes:
means for identifying the at least one recipient from a distribution list; and
means for sending the alarm message to the at least one recipient.

21. The apparatus of claim 19, wherein the maintenance instructions are retrieved from a maintenance database.

22. The apparatus of claim 19, wherein the maintenance instructions are stored in a maintenance database and the alarm message includes a reference to the maintenance instructions.

23. The apparatus of claim 19, wherein the identification means includes means for identifying the maintenance instructions based on the alarm in combination with at least one other alarm.

24. The apparatus of claim 19, wherein the at least one recipient includes at least one of a desktop computer, a laptop computer, a tablet computer, a telephone, or an electronic mail server.

25. An apparatus for direct maintenance of critical process equipment, the apparatus comprising:
receipt means for receiving an alarm message, wherein the alarm message includes maintenance instructions;
presentation means for presenting the maintenance instructions.

26. The apparatus of claim 25, wherein the maintenance instructions include main steps and detailed steps.

27. The apparatus of claim 26, wherein users of a first expertise level are required to complete the main steps and users of a second expertise level are required to complete the detailed steps.

28. The apparatus of claim 25, further comprising:
means for generating a resolution message responsive to maintenance being completed.

29. The apparatus of claim 25, further comprising:
means for generating an acknowledgement responsive to a maintenance instruction being completed.

30. The apparatus of claim 25, further comprising:
means for updating a maintenance log responsive to a maintenance instruction being completed.

31. The apparatus of claim 25, wherein the maintenance instructions include at least a first step and wherein the maintenance instruction includes a media file for the first step.

32. The apparatus of claim 31, further comprising:
means for presenting the media file to the user.

33. The apparatus of claim 32, further comprising:
means for presenting controls for interacting with the media file.

34. The apparatus of claim 31, wherein the media file is one of an audio file, an image, a diagram, a video file, and a three-dimensional model.

35. A computer program product, in a computer readable medium, for direct maintenance of critical process equipment, the computer program product comprising:
instructions for receiving an alarm;
instructions for identifying maintenance instructions for the alarm;
instructions for generating an alarm message, wherein the alarm message includes the maintenance instructions; and
instructions for distributing the alarm message to at least one recipient.

36. A computer program product, in a computer readable medium, for direct maintenance of critical process equipment, the computer program product comprising:
instructions for receiving an alarm message, wherein the alarm message includes maintenance instructions;
instructions for presenting the maintenance instructions.
